(19) United States
(12) Patent Application Publication
(10) Pub. No.: US 2025/0067843 A1
(43) Pub. Date: Feb. 27, 2025

(54) SYSTEM FOR TESTING AND ANALYSIS OF SIMULATED HIGH FIDELITY AIRBORNE RADAR CLUTTER DATA

(71) Applicant: Government of the United States, as represented by the Secretary of the Air Force, Wright-Patterson AFB, OH (US)

(72) Inventor: RAMACHANDRAN S. RAGHAVAN, Centerville, OH (US)

(21) Appl. No.: 18/407,623

(22) Filed: Jan. 9, 2024

Related U.S. Application Data
(60) Provisional application No. 63/533,774, filed on Aug. 21, 2023.

(51) Int. Cl. G01S 7/40; G01S 7/41

(52) U.S. Cl. CPC G01S 7/4052; G01S 7/414

(57) ABSTRACT

A system and method for testing and analysis of simulated high fidelity airborne radar clutter data is proposed. Such system and method employ radar clutter statistics for a transmitted waveform especially for multi-channel receive array that are not utilized for the purpose of testing the outputs produced by current tests. In short, such method for testing synthetically generated radar clutter data that is based on a thorough analysis of the performance of hypothesis tests where knowledge of the clutter-plus-noise covariance matrix over a specific subspace in addition to in-phase (I) and quadrature (Q) vector data of clutter-plus-noise is disclosed. The disclosed system and method are particularly applicable to airborne radar receiver data sets having large degrees of freedom.

### CROSS-REFERENCE TO RELATED APPLICATION

The present application claims priority to U.S. Provisional Application Ser. No. 63/533,774 filed Aug. 21, 2023, the contents of which is hereby incorporated by reference in their entry.

### RIGHTS OF THE GOVERNMENT

The invention described herein may be manufactured and used by or for the Government of the United States for all governmental purposes without the payment of any royalty.

### FIELD OF THE INVENTION

The present invention relates to systems and methods for testing and analysis of simulated high fidelity airborne radar clutter data.

### BACKGROUND FOR THE INVENTION

Adaptive detection algorithms for airborne radar applications are difficult to implement when the number of degrees of freedom (DOF) are very large (say>100). The DOF for space-time adaptive processing (STAP) is defined as the product of the number of uniform antenna elements in the receive array (Na) and the number of pulses transmitted (Np) in a coherent processing interval (CPI). The DOF is denoted by N=Na Np. Ground looking airborne radar systems must suppress ground clutter in order to detect ground moving targets, and information to suppress the clutter that interferes with the signal to be detected is in the clutter-plus-noise covariance matrix which is of dimension N×N. Generally, the covariance matrix is not known at the radar receiver. Software tools available have been developed that can provide samples of STAP clutter-plus-noise data given the airborne system geometry.

Given a file containing radar clutter samples generated for a software tool for a specific scenario, basic tests to estimate the mean and variance of clutter power received from different ranges and azimuth angles and match such estimates with the radar cross section is performed in the software. Current tests are decades old and produce results that are, at best, inadequate for today's high performance aerospace radars. Applicant recognized that the problem with current tests is rooted in the statistical treatment of simulated clutter data. Applicant provides a solution to the aforementioned problem herein. Applicant's solution employs radar clutter statistics for a transmitted waveform especially for multi-channel receive array that are not utilized for the purpose of testing the outputs produced by current tests. In short, a more detailed method for testing synthetically generated radar clutter data that is based on a thorough analysis of the performance of hypothesis tests where knowledge of the clutter-plus-noise covariance matrix over a specific subspace in addition to in-phase (I) and quadrature (Q) vector data of clutter-plus-noise is disclosed. The disclosed system and method are particularly applicable to data sets having large degrees of freedom. In summary, Applicant's software improves the functioning of a computer system used to validate computer simulated radar clutter data as Applicant's software allows for surprisingly rapid, efficient and detailed validations.

### SUMMARY OF THE INVENTION

A system and method for testing and analysis of simulated high fidelity airborne radar clutter data. Such system and method employs radar clutter statistics for a transmitted waveform especially for multi-channel receive array that are not utilized for the purpose of testing the outputs produced by current tests. In short, such method for testing synthetically generated radar clutter data that is based on a thorough analysis of the performance of hypothesis tests where knowledge of the clutter-plus-noise covariance matrix over a specific subspace in addition to in-phase (I) and quadrature (Q) vector data of clutter-plus-noise is disclosed. The disclosed system and method are particularly applicable to data sets having large degrees of freedom.

Additional objects, advantages, and novel features of the invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about.” “approximately,” or the like, when accompanying a numerical value, are to be construed as indicating a deviation as would be appreciated by one of ordinary skill in the art to operate satisfactorily for an intended purpose

As used herein, the words “and/or” means, when referring to embodiments (for example an embodiment having elements A and/or B) that the embodiment may have element A alone, element B alone, or elements A and B taken together.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### A Method of Testing Synthetically Generated Radar Clutter Samples

Applicants disclose a method for testing synthetically generated I/Q STAP data for airborne systems with very large DOF. Tests are performed for each of several pre-specified probability of false alarms and set of pre-specified system parameters. Test results are based on: determining a required threshold for a probability of false alarm; computing a detection statistic from the software generated I/Q vector sample data over one coherent processing interval for one or more given ranges; computing the quantities necessary for selecting a significantly smaller set of dimensions compared to DOF using the eigenvalues and eigenvectors of the full dimension clutter-plus-noise matrix obtained from the software tool and the pre-specified signal vector:;transforming the reduced dimension I/Q vector samples using the information about the clutter-plus-noise covariance submatrix provided by the software tool; comparing the said threshold and said detection statistic computed from transformed reduced dimension data; and if said detection statistic is greater than or equal to said threshold a detection counter is augmented by one; the said test is performed over multiple realizations of I/Q clutter-plus-noise vector samples generated by the software tool: the empirical estimate of the probability of detection from the tests for each signal-to-clutter-pls-noise ratio obtained from the detection counter and number of trials performed: comparing the empirical estimate of the probability of detection which is compared with theoretical predictions; such comparisons performed over several pre-specified probability of false alarm and signal vector choices and signal-to-noise ratios are used to produce test results.

Applicants disclose a system for testing and analysis of simulated high fidelity airborne radar space-time clutter data comprising a computer comprising simulated high fidelity airborne radar space-time clutter data, said computer programmed to:

a) Find eigenvectors and eigenvectors of a clutter-plus-noise covariance matrix of a software generated simulated high fidelity airborne radar space-time clutter data set using an Eigenequation as follows:

$${Rv}_{n} = {λ}_{n} {v}_{n} ; n = 1 , 2 , … , N$$

b) Define a signal vector as a Kronecker product of spatial and temporal signal vectors using the following equations:

$${{s}_{t} = - 1 {e}^{j 2 π {f}_{d} {T}_{\text{?}}} … {e}^{j 2 π ( {N}_{p} - 1 ) {f}_{d} {T}_{\text{?}}} ]}^{T}$$

$${s}_{s} = {[ 1 {e}^{- j π sin θ cos ψ} … {e}^{- j π ( {N}_{a} - 1 ) sin θ cos ψ} ]}^{T}$$

$$s = {s}_{s} \text{?} {s}_{t}$$

$$\text{?} \text{indicates text missing or illegible when filed}$$

c) Generate a scaled signal vector by:
   (i) Evaluating cross-spectral coefficients from the signal vector, the eigenvectors and eigenvalues of R using the following equation:

$${γ}_{n} = \frac{{\vert {s}^{H} {v}_{n} \vert}^{2}}{{λ}_{n}} ; n = 1 , 2 , … , N$$

(ii) Arranging the cross-spectral coefficients in decreasing order of magnitude and identifying corresponding eigenvectors and representing said arranged cross-spectral coefficients in the following manner:

$${γ}_{( 1 )} \geq {γ}_{( 2 )} \geq {γ}_{( 3 )} \geq … \geq {γ}_{( M )} >> {γ}_{( M + 1 )} \geq {γ}_{( N )} > 0$$

$${γ}_{( n )} = \frac{{\vert {s}^{H} {v}_{n} \vert}^{2}}{{λ}_{n}} ; n = 1 , 2 , … , M$$

(iii) Selecting reduced rank space-time dimensions M for a clutter suppression using a set said eigenvectors, said set of eigenvectors represented by the following equation:

$${v}_{( 1 )} , {v}_{( 2 )} , … {v}_{( M )}$$

(iv) Appling a Gram-Schmidt orthonormal procedure to find an orthonormal basis set of vectors for the said selected space-time dimension using the following equations:

```
w₁ = s
u₁ = w₁/||w₁||
w₂ = v₍₁₎ − (u₁^{H}v₍₁₎)u₁
u₂ = w₂/||w₂||
  For n = 3:M
${w}_{m} = {v}_{( n - 1 )} - {\sum }_{m = 1}^{n - 1} ( {u}_{m}^{H} {v}_{( n - 1 )} ) {u}_{m}$
uₙ = wₙ/||wₙ||
  end
```

(v) Defining a matrix U of size N×M, having columns that comprise said orthonormal basis vectors, said matrix U being represented by the following equation;

$$U = [ {u}_{1} {u}_{2} … {u}_{M} ]$$

(vi) Pre-multiplying said software generated simulated high fidelity airborne radar space-time clutter data set plus noise I/Q vectors by a conjugate transpose of U using the following equations:

$$z \to {U}^{H} z$$

$${y}_{n} \to {U}^{H} {y}_{n} ; n = 1 , 2 , … , L$$

$$Y \to [ {y}_{1} {y}_{2} … {y}_{L} ]$$

(vii) Defining a M×M clutter-plus-noise covariance matrix in a reduced dimension space as the following equation:

$$Σ = {U}^{H} RU = [ \begin{matrix}{Σ}_{11} & {Σ}_{12} \\ {Σ}_{12}^{H} & {Σ}_{22}\end{matrix} ]$$

(viii) Defining a signal-to-clutter-plus-noise ratio in said reduced dimension space using the following equation:

$$c = {\vert α \vert}^{2} {‖ s ‖}^{2} {( {Σ}_{11} - {Σ}_{12} {Σ}_{22}^{- 1} {Σ}_{12}^{H} )}^{- 1}$$

and defining α from said equation for said signal-to-clutter-plus-noise ratio in said reduced dimension space;
(ix) Adding said defined α to said signal vector to generate a scaled signal vector and adding said scaled signal vector to a test cell vector and performing the following hypothesis test for the test cell vector:

$$z = \{ \begin{matrix}x & if {H}_{0} \\ x + α s ; & if {H}_{1}\end{matrix}$$

d.) Define a clutter-plus-noise covariance matrix with a cross-correlation set to 0 using the following equation:

$${\sum }_{p} = [ \begin{matrix}{\sum }_{11} & {0}_{1 \times M - 1} \\ {0}_{M - 1 \times 1} & {\sum }_{22}\end{matrix} ]$$

e) Apply a linear transform to said test cell vector, and said L training vectors of Step (iv) to whiten a set of clutter-plus-noise samples in dimensions orthogonal to said signal vector to provide a transformed data set in partitioned form represented by the following equations:

$$z \to {\sum }_{p}^{- 1 / 2} z = [ \begin{matrix}{z}_{1} \\ {z}_{2}\end{matrix} ]$$

$$Y \to {\sum }_{p}^{- 1 / 2} Y = [ \begin{matrix}{y}_{1} \\ {Y}_{2}\end{matrix} ]$$

f) Suppress clutter in said test cell using a reduced dimension and a whitened I/Q vectors data set comprising clutter-plus-noise from L reference cells to estimate the following correlation coefficients:

$${\tilde{z}}_{1.2} = ( {z}_{1} - \text{?} \text{?} )$$

$$\text{?} = {y}_{1} {Y}_{2}^{H} {\vert {Y}_{2} {Y}_{2}^{H} \vert}^{- 1}$$

$$\text{?} \text{indicates text missing or illegible when filed}$$

g) Generate a detection statistic from a clutter suppressed component from said test cell and implement the following decision rule based on a probability of false alarm (PFA) generated using the following PFA equation below:
   Decision rule:

$${\vert {\tilde{z}}_{1.2} \vert}^{2} {{⋛ η}_{{H}_{0}}}^{{H}_{1}}$$

$$\begin{matrix}{P}_{F A} = P [ {\vert {\tilde{z}}_{1.2} \vert}^{2} > η \vert {H}_{0} ] = P [ x > \tilde{ρ} η ] \\ = {\int }_{0}^{1} {e}^{- η \tilde{p}} f ( \tilde{ρ )} d \tilde{ρ}\end{matrix}$$

wherein for said PFA equation the probability density function of the signal-to-noise ratio loss factor is obtained from the following equivalent statistical representation. Independent trials (in the order of 100000) are run to generate samples of the loss factor and the probability density function is obtained from a histogram of the random variable realizations.

$$ρ \text{?} \frac{1}{1 + {q}^{H} Aq}$$

$$A = {{Y}_{2}^{H} [ {Y}_{2} {Y}_{2}^{H} ]}^{- 2} {Y}_{2}$$

$$q \text{?} {𝒩}_{c} ( {0}_{( M - 1 )} \text{?} {I}_{( M - 1 )} )$$

$$\text{?} \text{indicates text missing or illegible when filed}$$

h) Determine if said detection statistic, exceeds the threshold of said decision rule, and record a count of said determination;
i) Repeat Steps a) through h) at least 100 times, preferably at least 1000 times to obtain a stable empirical estimate of a probability of a detection;
j) Compare said stable empirical estimate of the probability of the detection with an analytical probability of a detection calculated using the following equations:

$$\begin{matrix}[ {P}_{D} \vert \tilde{p} ] = P [ x > \tilde{ρ} η \vert \tilde{ρ} ] \\ = {\int }_{η \tilde{ρ}}^{∞} {e}^{- ( x + c \tilde{ρ} )} {I}_{0} ( 2 \sqrt{xc \tilde{ρ}} ) dx = Q ( \sqrt{2 c \tilde{ρ}} , 2 \sqrt{2 η \tilde{ρ}} )\end{matrix}$$

$${P}_{D} = {\int }_{0}^{1} Q ( \sqrt{2 c \tilde{ρ}} , \sqrt{2 η \tilde{ρ}} f ( \tilde{ρ} ) d \tilde{ρ}$$

$$wherein$$

$$Q ( α , β ) = {\int }_{0}^{∞} υ {e}^{- ( {v}^{2} + {α}^{2} ) / 2} {I}_{0} ( α υ ) d υ$$

and determine the difference between said stable empirical estimate of the probability of the detection and analytical probability of a detection;
k) Repeat Steps a) through j) for at least three PFAs, preferably said PFAs are less than 1×10⁻³, for signal to clutter plus noise ratios in the range of about 5 dB to 25 dB; and
l) Report the comparison of said stable empirical estimate of the probability of the detection with said analytical probability of the detection to human. The human then judges the acceptability of the simulated high fidelity airborne radar space-time clutter data for the particular task at hand based on such reported result.

Applicants disclose the system for testing and analysis of simulated high fidelity airborne radar space-time clutter data of the previous paragraph wherein said computer comprises a random access memory, a partitioning operating system, a data storage module. In general a partitioning operating system that will allow scientific computer software, such as Matlab to operate, will suffice for the present application and the data storage module is capable of allowing a human to access the results stored therein.

### Detailed Mathematics of Method

A detailed mathematical description of the processing of a set of in-phase (I) and quadrature (Q) STAP clutter-plus-noise vectors generated by software tool is described. The software tool is first used to generate the following information for an assumed scenario and geometry: (i) a full dimension covariance matrix of the clutter-plus-noise radar return from a selected range resolution cell. The covariance matrix denoted by R is a Hermitian matrix of size N×N (ii) sample I/Q space-time vectors from L range cells in the vicinity of a selected test cell (iii) space-time clutter-plus-noise return from a preselected test cell. For hypothesis Hl, a signal vector s comprising a temporal part defined by the relative radial velocity of the target with respect to the airborne monostatic radar and a spatial part defined by the azimuth angle and elevation angle of the target with respect to the receive antenna array. The signal vector is scaled by a constant α is added to the test cell clutter-plus-noise vector for hypothesis H1. The scale factor is α is selected such that the signal-to-clutter-plus-noise ratio is at pre-selected value. The detailed steps in the processing as the following:
(i) Find the eigenvectors and eigenvectors of clutter-plus-noise covariance matrix provided by software tool: Eigenequation:

$${Rv}_{n} = {λ}_{n} {v}_{n} ; n = 1 , 2 , … , N$$

(ii) Define signal vector as the Kronecker product of spatial and temporal signal vectors:

$${s}_{t} = {[ 1 {e}^{j 2 π {f}_{d} {T}_{o}} … {e}^{j 2 π ( {N}_{p} - 1 ) {f}_{d} {T}_{o}} ]}^{T}$$

$${s}_{s} = {[ 1 {e}^{- j π sin θ cos ψ} … {e}^{- j π ( {N}_{a} - 1 ) sin θ cos ψ} ]}^{T}$$

$$s = {s}_{s} ⊗ {s}_{t}$$

(iii) The hypothesis test for the test cell vector:

$$z = \{ \begin{matrix}x & if {H}_{0} \\ x + α s ; & if {H}_{1}\end{matrix}$$

(iv) Evaluate the cross-spectral coefficients from the signal vector s, the eigenvectors and eigenvalues of R:

$${γ}_{n} = \frac{{\vert {s}^{H} {v}_{n} \vert}^{2}}{{λ}_{n}} ; n = 1 , 2 , … , N$$

(v) Arrange the coefficients in decreasing order of magnitude and identify the corresponding eigenvectors:

$${γ}_{( 1 )} \geq {γ}_{( 2 )} \geq {γ}_{( 3 )} \geq … \geq {γ}_{( M )} >> {γ}_{( M + 1 )} \geq {…γ}_{( N )} > 0$$

$${γ}_{n} = \frac{{\vert {s}^{H} {v}_{( n )} \vert}^{2}}{{λ}_{( n )}} ; n = 1 , 2 , … , M$$

(vi) Select reduced rank space-time dimensions (say M) for clutter suppression using eigenvectors that result in the largest M cross-spectral coefficients. The number of space-time dimensions for clutter suppression (M) is significantly smaller than N (i.e. M<<N) for systems with very large DOF.
Basis vectors of reduced dimension space-time subspace:

$${v}_{( 1 )} , {v}_{( 2 )} , … {v}_{( M )}$$

(vii) Apply Gram-Schmidt orthonormal procedure to find an orthonormal basis set of vectors for the selected dimension in (iv). Gram-Schmidt procedure to generate orthonormal basis:

$${w}_{1} = s$$

$${u}_{1} = {w}_{1} / ‖ {w}_{1} ‖$$

$${w}_{2} = {v}_{( 1 )} - ( {u}_{1}^{H} {v}_{( 1 )} ) {u}_{1}$$

$${u}_{2} = {w}_{2} / ‖ {w}_{2} ‖$$

$$For n = 3 : M$$

$${w}_{n} = {v}_{( n - 1 )} - {\sum }_{m = 1}^{n - 1} ( {u}_{m}^{H} {v}_{( n - 1 )} ) {u}_{m}$$

$${u}_{n} = {w}_{n} / ‖ {w}_{n} ‖$$

$$end$$

(viii) Define a matrix U of size N×M, whose columns are the orthonormal basis vectors in (vi):

$$U = [ {u}_{1} {u}_{2} … {u}_{M} ]$$

(ix) Pre-multiply all space-time clutter plus noise I/Q vectors by conjugate transpose of U. Vectors processed are space-time vector from L reference range cells that are clutter-plus-noise only and vector from test cell, which contains an added signal for hypothesis (H1) (at described in item (iii) above. For hypothesis (H0), the test cell return is clutter-plus-noise only.

$$z \to {U}^{H} z$$

$${y}_{n} \to {U}^{H} {y}_{n} ; n = 1 , 2 , … , L$$

$$Y \to [ {y}_{1} {y}_{2} … {y}_{L} ]$$

(x) Define a M×M clutter-plus-noise covariance matrix in reduced dimension space:

$$Σ = {U}^{H} RU = [ \begin{matrix}{Σ}_{11} & {Σ}_{12} \\ {Σ}_{12}^{H} & {Σ}_{22}\end{matrix} ]$$

(xi) Define signal-to-clutter-plus-noise ratio (SCNR) in reduced dimension space:

$$c = {\vert α \vert}^{2} {‖ s ‖}^{2} {( {Σ}_{11} - {Σ}_{12} {Σ}_{22}^{- 1} {Σ}_{12}^{H} )}^{- 1}$$

(xii) Define clutter-plus-noise covariance matrix with cross-correlation set to 0 (these coefficients will be estimated from I/Q data):

$${Σ}_{p} = [ \begin{matrix}{Σ}_{11} & {0}_{1 \times M - 1} \\ {0}_{M - 1 \times 1} & {Σ}_{22}\end{matrix} ]$$

(xiii) Apply linear transform to test vector and training vectors to whiten clutter-plus-noise samples in dimension orthogonal to signal and represent transformed data in partitioned form:

$$z \to {Σ}_{p}^{- 1 / 2} z = [ \begin{matrix}{z}_{1} \\ {z}_{2}\end{matrix} ]$$

$$Y \to {Σ}_{p}^{- 1 / 2} Y = [ \begin{matrix}{y}_{1} \\ {Y}_{2}\end{matrix} ]$$

(xiv) Suppress clutter in the signal space using reduced dimension and whitened I/Q clutter-plus-noise data from L reference cells to estimate the correlation coefficients:

$${{z}^{\text{?}}}_{\text{?}} = ( {z}_{1} - {{r}^{\text{?}}}_{\text{?}} {z}_{2} )$$

$${{r}^{\text{?}}}_{\text{?}} = {y}_{1} {{Y}_{2}^{H} [ {Y}_{2} {Y}_{2}^{H} ]}^{- 1}$$

$$\text{?} \text{indicates text missing or illegible when filed}$$

(xv) Generate the detection statistic from clutter suppressed component from test cell and implement the decision rule. The threshold selected is based on a desired PFA and is given in (xvi)
Decision rule:

$${\vert {{z}^{\text{?}}}_{1.2} \vert}^{2} \begin{matrix}{H}_{1} \\ > \\ < \\ {H}_{0}\end{matrix} η$$

$$\text{?} \text{indicates text missing or illegible when filed}$$

(xvi) Repeat steps (viii), (xii), (xiii) and (xiv) for a new set of synthetically generated space-time clutter-plus-noise vectors from reference cells and test cell. Steps are repeated for different SCNR as well. An empirical estimate of the probability of detection is the ratio of the number of trials where the decision statistic exceeds the pre-selected threshold to the total number of trials.
(xvii) Analytical expression for the PFA and PD for the process described in this section is [2]:
Threshold level for a desired PFA:

$$\begin{matrix}{P}_{FA} = P [ {\vert {{z}^{\text{?}}}_{1.2} \vert}^{2} > η [ {H}_{0} ] = P [ x > {ρ}^{\text{?}} η ] \\ = {\int }_{0}^{1} {e}^{- η {ρ}^{\text{?}}} f {ρ}^{\text{?}} d {ρ}^{\text{?}}\end{matrix}$$

$$\text{?} \text{indicates text missing or illegible when filed}$$

Probability of detection for a SCNR=c:

$$\begin{matrix}[ {P}_{D} \vert {ρ}^{\text{?}} ] = P [ x > {ρ}^{\text{?}} η \vert {ρ}^{\text{?}} ] \\ = {\int }_{η {ρ}^{\text{?}}}^{∞} {e}^{1 ( x + \text{?} {ρ}^{\text{?}} )} {I}_{0} ( 2 \sqrt{xc {ρ}^{\text{?}}} ) dx = Q ( \sqrt{2 c {ρ}^{\text{?}}} , \sqrt{2 η {ρ}^{\text{?}}} )\end{matrix}$$

$${P}_{D} = {\int }_{0}^{1} Q ( \sqrt{2 c {ρ}^{\text{?}}} , \sqrt{2 η \tilde{\text{?}}} ) f ( {ρ}^{\text{?}} ) d {ρ}^{\text{?}}$$

$$\text{?} \text{indicates text missing or illegible when filed}$$

Marcum Q-function definition:

$$Q ( α , β ) = {\int }_{β}^{∞} v {e}^{- ( {v}^{2} + {α}^{2} ) / 2} {I}_{0} ( α v ) d v$$

SCNR loss factor has an equivalent statistical representation that is the following:

$${p}^{\text{?}} {∼}^{dist} \frac{1}{1 + {q}^{H} A q}$$

$$A = {{Y}_{2}^{H} [ {Y}_{2} {Y}_{2}^{H} ]}^{- 2} {Y}_{2}$$

$$q {∼}^{dist} {𝒩}_{\text{?}} ( {0}_{( M - 1 ) \times \text{?}} {I}_{( M - 1 )} )$$

$$\text{?} \text{indicates text missing or illegible when filed}$$

The Probability Density Function (PDF) of the signal-to-noise ratio loss factor is obtained from the equivalent statistical representation. Independent trials (in the order of 100000) are run to generate samples of the loss factor and the PDF is obtained from a histogram of the samples generated.

wherein the needed variable definitions for the equations above are as follows:

| | Nomenclature |
|---|---|
| N = N [symbol] N [symbol] : | number of space-time degrees of freedom (DOF). |
| [symbol] | number of antenna elements in receive linear array. |
| [symbol] | number of pulses transmitted in a coherent processing |
| | interval (CPI). |
| [symbol] | pulse repetition interval. |
| θ: | azimuth angle of clutter cell from boresite direction. |
| f_{d}: | Doppler frequency of target relative to receive |
| | array = k( [symbol] − vᵣ)/2π: |
| k: | vector pointed in the direction of signal transmission |
| | and magnitude = 2π/λ. |
| λ: | wavelength of carrier signal. |
| [symbol] | velocity vector of target. |
| vᵣ: | velocity vector of receive array |
| R: | full dimension clutter-plus-noise covariance matrix. |
| s: | space-time signal vector. |
| [symbol] n = 1, | cross-spectral coefficients computed from eigenvalues and |
| 2, . . . , N: | eigenvectors of R and signal vector s. |
| M: | size of reduced dimension space corresponding to |
| | the number of largest cross-spectral coefficients M << N. |
| [symbol] n = 1, | orthonormal basis vectors of reduced dimension STAP. |
| 2, . . . , M | |
| [symbol] n = 1, | orthonormal basis vectors for reduced dimension obtained |
| 2, . . . , M: | from [symbol] vectors using Gram-Schmidt orthogonalization |
| | with [symbol] = s/\|\|s\|\| . . . All other vectors are |
| | orthogonal to signal vector. |
| Σ: | clutter-plus-noise covariance matrix for reduced dimension. |
| H₀: | Null hypothesis that test cell contains no signal. |
| H₁: | Alternative hypothesis that test cell contains signal plus |
| | clutter-plus-noise. |
| [symbol] | clutter-plus-noise vector of length N at test cell. |
| x: | clutter-plus-noise vector of length N at test cell. |
| z: | scaled signal [symbol] added to clutter-plus-noise x for hypothesis |
| | H₁. For hypothesis H₀ no signal is added to x. |
| [symbol] | scale parameter determined by required |
| | Signal-to-clutter-plus-noise ratio. |
| [symbol] | Signal-to-clutter-plus-noise |
| | ratio = \| [symbol] \|²\|\|s\|\|²(Σ₁₁ − Σ₁₂Σ₂₂⁻¹Σ₁₂ [symbol] )⁻¹ |
| Y: | matrix of size M × L containing reduced dimension |
| | space-time clutter-plus-noise vectors from L reference cells. |
| [symbol] | SCNR loss factor. |
| [symbol] [symbol] (a, R): | Multivariate complex Gaussian distribution with mean |
| | vector a and covariance matrix R. |
| [symbol] | Distribured as. |

[symbol]

indicates data missing or illegible when filed

The aforementioned detailed mathematics (algorithm) can be programmed into a module/computer that provides clutter suppressed test statistic for signal detection as a result of such algorithm. Such a system can be programed into a module using Matlab and can be converted to C++, C #or another coding language. The module must have access to the clutter-plus-noise software tool that is being tested to obtain an estimate of the space-time clutter-plus-noise covariance matrix for a specified problem geometry and also obtain multiple realizations (for multiple trials) of clutter-plus-noise I/Q sample vectors from a specified range cell under test and L reference clutter cells. The mathematical description of the algorithm has several useful features and advantages as described in the examples below.

Numerous software tools to generate synthetic radar data are currently available. The software tools generally provide estimates of the clutter-plus-noise power received from different resolution cells and color images of the plots but do not utilize rigorous methods to test the validity of such data for a given geometry and scenario using statistical methods and principles of physics that govern the properties of such data for systems with very large degrees of freedom (DOF). This patent proposes an approach for testing synthetically generated STAP clutter-plus-noise radar data for airborne systems that involve very large DOFs. The proposed approach combined with software for generating synthetic STAP data is anticipated to result in a significantly improved software for high fidelity airborne radar clutter data. The following advantages are obtained when the aforementioned detailed mathematics (algorithm) are programmed into a module/computer and such module/computer is used to process simulated high fidelity airborne radar clutter data. First, the computer provides more accurate results more efficiently.

### EXAMPLES

### Example 1: Selection of Reduced Dimension Size

For a specific space-time signal to be detected in clutter, the algorithm uses the clutter-plus-noise covariance matrix predicted by the software tool to find the space-time channels that can effectively suppress the clutter in the signal channel. The number of such channels to be used in the processing (M) can be selected by the user and can be significantly smaller than the DOF. This feature of the invention is very useful from an implementation point-of-view as it gives complete control to the user and is made possible only because all the channels orthogonal to the signal have been whitened and made statistically independent to each other for the Gaussian clutter model. Importantly, the signal-to-clutter-plus-noise ratio is defined by items (x) and (xi) in the mathematical description section for any selected M. With a reduced set of space-time dimensions, clutter-plus-noise I/Q samples vectors provided by the software tool is used to estimate the correlation coefficients and weights required to suppress clutter that interferes with the signal as described in item (xiv) of the mathematical description section. The magnitude square of the clutter suppressed test vector is the test statistic which is compared to a threshold as shown in item (xv) of the mathematical description section.

### Example 2: Incorporation of Measured Radar I/Q Data in Testing

Measured I/Q airborne radar data for the same geometry and scenario as used in the software tool can be substituted for the simulated I/Q data produced by the software tool for generating the detection statistic and the detection probability estimates. These results can be compared with corresponding results of detection probability obtained from simulated I/Q clutter data. In both cases, the clutter-plus-noise covariance submatrix estimate for channels orthogonal to the signal produced by the software tool are used to whiten the orthogonal channels of the measured data and/or simulated data and suppress the clutter in the signal channel as described in steps (ix) through (xv) of the mathematical description section.

What is claimed:

1. A system for testing and analysis of simulated high fidelity airborne radar space-time clutter data comprising a computer comprising software generated, simulated high fidelity airborne radar space-time clutter data, said computer programmed to:
a) Find eigenvectors and eigenvectors of a clutter-plus-noise covariance matrix of said software generated simulated high fidelity airborne radar space-time clutter data set using an Eigenequation below:
$$R {v}_{n} = {λ}_{n} {v}_{n} ; n = 1 , 2 , … , N$$
b) Define a signal vector as a Kronecker product of spatial and temporal signal vectors using the following equations:
$${s}_{t} = {[ 1 {e}^{j 2 π {f}_{d} {T}_{\text{?}}} … {e}^{j 2 π ( {N}_{p} - 1 ) {f}_{d} {T}_{\text{?}}} ]}^{T}$$
$${s}_{s} = {[ 1 {e}^{- j {π sin θ cos ψ…e}^{- j π ( {N}_{a} - 1 ) sin θ cos ψ}} ]}^{T}$$
$$s = {s}_{s} ⊗ {s}_{t}$$
$$\text{?} \text{indicates text missing or illegible when filed}$$
c) Generate a scaled signal vector by:
(i) Evaluating cross-spectral coefficients from the signal vector, the eigenvectors and eigenvalues of R from step a) using the following equation:
$${γ}_{n} = \frac{{\vert {s}^{H} {v}_{n} \vert}^{2}}{{λ}_{n}} ; n = 1 , 2 , … , N$$
(ii) Arranging the cross-spectral coefficients in decreasing order of magnitude and identifying corresponding eigenvectors and representing said arranged cross-spectral coefficients in the following manner:
$${γ}_{n} = \frac{{\vert {s}^{H} {v}_{n} \vert}^{2}}{{λ}_{n}} ; n = 1 , 2 , … , M$$
(iii) Selecting reduced rank space-time dimensions M for a clutter suppression using a set said eigenvectors, said set of eigenvectors represented by the following equation:
$${v}_{( 1 )} , {v}_{( 2 )} , … {v}_{( M )}$$
(iv) Appling a Gram-Schmidt orthonormal procedure to find an orthonormal basis set of vectors for the said selected space-time dimension using the following equations:
$${w}_{1} = s$$
$${u}_{1} = {w}_{1} / ‖ {w}_{1} ‖$$
$${w}_{2} = {v}_{( 1 )} - ( {u}_{1}^{H} {v}_{( 1 )} ) {u}_{1}$$
$${u}_{2} = {w}_{2} / ‖ {w}_{2} ‖$$
$$For n = 3 : M$$
$${w}_{n} = {v}_{( n - 1 )} - {\sum }_{m = 1}^{n - 1} ( {u}_{m}^{H} {v}_{( n - 1 )} ) {u}_{m}$$
$${u}_{n} = {w}_{n} / ‖ {w}_{n} ‖$$
$$end$$
(v) Defining a matrix U of size N x M, having columns that comprise said orthonormal basis vectors, said matrix U being represented by the following equation;
$$U = [ {u}_{1} {u}_{2} … {u}_{M} ]$$
(vi) Pre-multiplying said software generated simulated high fidelity airborne radar space-time clutter data set plus noise I/Q vectors by a conjugate transpose of U using the following equations:
$$z \to {U}^{H} z$$
$${y}_{n} \to {U}^{H} {y}_{n} ; n1 , 2 , … , L$$
$$Y \to [ {y}_{1} {y}_{2} … {y}_{L} ]$$
(vii) Defining a M x M clutter-plus-noise covariance matrix in a reduced dimension space as the following equation:
$$\sum = {U}^{H} RU = [ \begin{matrix}{\sum }_{11} & {\sum }_{12} \\ {\sum }_{12}^{H} & {\sum }_{22}\end{matrix} ]$$
(viii) Defining a signal-to-clutter-plus-noise ratio in said reduced dimension space using the following equation:
$$c = {\vert α \vert}^{2} {‖ s ‖}^{2} {( {\sum }_{11} - {\sum }_{12} {\sum }_{22}^{- 1} {\sum }_{12}^{H} )}^{- 1}$$
and defining a from said equation for said signal-to-clutter-plus-noise ratio in said reduced dimension space;
(ix) Adding said defined a to said signal vector to generate a scaled signal vector and adding said scaled signal vector to a test cell vector and performing the following hypothesis test for the test cell vector:
$$z = \{ \begin{matrix}x & if {H}_{0} \\ x + α s ; & if {H}_{1}\end{matrix}$$
d) Define a clutter-plus-noise covariance matrix with a cross-correlation set to 0 using the following equation:
$${\sum }_{p} = [ \begin{matrix}{\sum }_{11} & {0}_{1 \times M - 1} \\ {0}_{M - 1 \times 1} & {\sum }_{22}\end{matrix} ]$$
e) Apply a linear transform to said test cell vector, and said L training vectors of Step c) (iv) to whiten a set of clutter-plus-noise samples in dimensions orthogonal to said signal vector to provide a transformed data set in partitioned form represented by the following equations:
$$z \to {\sum }_{p}^{- 1 / 2} z = [ \begin{matrix}{z}_{1} \\ {z}_{2}\end{matrix} ]$$
$$Y \to {\sum }_{p}^{- 1 / 2} Y = [ \begin{matrix}{y}_{1} \\ {y}_{2}\end{matrix} ]$$
f) Suppress clutter in said test cell using a reduced dimension and a whitened I/Q vectors data set comprising clutter-plus-noise from L reference cells to estimate the following correlation coefficients:
$${\tilde{z}}_{1.2} = ( {z}_{1} - \text{?} \text{?} )$$
$$\text{?} = {y}_{1} {Y}_{2}^{H} {\vert {Y}_{2} {Y}_{2}^{H} \vert}^{- 1}$$
$$\text{?} \text{indicates text missing or illegible when filed}$$
g) Generate a detection statistic from a clutter suppressed component from said test cell and implement the following decision rule based on a probability of false alarm (PFA) generated using the following PFA equation below:
$$Decision rule :$$
$${\vert {\tilde{z}}_{1.2} \vert}^{2} {{⋛ η}_{{H}_{0}}}^{{H}_{1}}$$
$$\begin{matrix}{P}_{F A} = P [ {\vert {\tilde{z}}_{1.2} \vert}^{2} > η \vert {H}_{0} ] = P [ x > \tilde{ρ} η ] \\ = {\int }_{0}^{1} {e}^{- η \tilde{p}} f ( \tilde{ρ )} d \tilde{ρ}\end{matrix}$$
wherein for said PFA equation the probability density function (PDF) of the signal-to-noise ratio loss factor is obtained from the following equivalent statistical representation:
$$ρ \text{?} \frac{1}{1 + {q}^{H} Aq}$$
$$A = {{Y}_{2}^{H} [ {Y}_{2} {Y}_{2}^{H} ]}^{- 2} {Y}_{2}$$
$$q \text{?} {𝒩}_{c} ( {0}_{( M - 1 )} \text{?} {I}_{( M - 1 )} )$$
$$\text{?} \text{indicates text missing or illegible when filed}$$
hePDF running at least 100,000 independent trials to generate a histogram of samples of the loss factor and obtaining the PDF from said histogram.
h) Determine if said detection statistic, exceeds the threshold of said decision rule, and record a count of said determination;
i) Repeat Steps a) through h) at least 100 times to obtain a stable empirical estimate of a probability of a detection;
j) Compare said stable empirical estimate of the probability of the detection with an analytical probability of a detection calculated using the following equations:
$$\begin{matrix}[ {P}_{D} \vert \tilde{p} ] = P [ x > \tilde{ρ} η \vert \tilde{ρ} ] \\ = {\int }_{η \tilde{ρ}}^{∞} {e}^{- ( x + c \tilde{ρ} )} {I}_{0} ( 2 \sqrt{xc \tilde{ρ}} ) dx = Q ( \sqrt{2 c \tilde{ρ}} , 2 \sqrt{2 η \tilde{ρ}} )\end{matrix}$$
$${P}_{D} = {\int }_{0}^{1} Q ( \sqrt{2 c \tilde{ρ}} , \sqrt{2 η \tilde{ρ}} f ( \tilde{ρ} ) d \tilde{ρ}$$
$$wherein$$
$$Q ( α , β ) = {\int }_{0}^{∞} υ {e}^{- {v}^{2} + {α}^{2} ) / 2} {I}_{0} ( α υ ) d υ$$
and determine the difference between said stable empirical estimate of the probability of the detection and analytical probability of a detection;
k) Repeat Steps a) through j) for at least three PFAs, preferably said PFAs are less than 1×10⁻³, for signal to clutter plus noise ratios in the range of about 5 dB to 25 dB; and
l) Report the comparison of said stable empirical estimate of the probability of the detection with said analytical probability of the detection to human.)

2. The system for testing and analysis of simulated high fidelity airborne radar space-time clutter data of claim 1 wherein Steps a) through h) are repeated at least at least 1000 times.)

3. The system for testing and analysis of simulated high fidelity airborne radar space-time clutter data of claim 1 wherein Steps a) through j) are repeated for three to less than 1×10⁻³ PF As.

4. The system for testing and analysis of simulated high fidelity airborne radar space-time clutter data of claim 1 wherein said computer comprises a random access memory, a partitioning operating system, a data storage module.
